(19) United States
(12) Patent Application Publication
(10) Pub. No.: US 2014/0195340 A1
(43) Pub. Date: Jul. 10, 2014

(54) ADVERTISEMENT INFORMATION PROVIDING DEVICE AND ADVERTISEMENT INFORMATION PROVIDING METHOD

(71) Applicant: YAHOO JAPAN CORPORATION, Tokyo (JP)

(72) Inventors: Toru HOTTA, Tokyo (JP); Masashi TSUBOSAKA, Tokyo (JP)

(73) Assignee: YAHOO JAPAN CORPORATION, Tokyo (JP)

(21) Appl. No.: 14/141,105

(22) Filed: Dec. 26, 2013

(30) Foreign Application Priority Data
Jan. 8, 2013 (JP) 2013-000859

(51) Int. Cl. G06Q 30/02

(52) U.S. Cl. CPC G06Q 30/0247
USPC 705/14.46

(57) ABSTRACT

An advertisement information providing device includes an advertisement content storage unit that stores advertisement content of a plurality of types. The advertisement information providing device includes an expected earning calculation unit that calculates expected earnings per unit impression number for each type of the advertisement content or for a combination of a plurality of types of the advertisement content. The advertisement information providing device includes an advertisement content type determination unit that determines which type of the advertisement content or combination of types of the advertisement content is to be delivered based on the expected earnings. The advertisement information providing device includes an advertisement content delivery unit that acquires the type of the advertisement content or combination of types of the advertisement content and delivers the advertisement content to an advertisement space.

### CROSS-REFERENCE TO RELATED APPLICATIONS

The present application claims priority to and incorporates by reference the entire contents of Japanese Patent Application No. 2013-000859 filed in Japan on Jan. 8, 2013.

### BACKGROUND OF THE INVENTION

1. Field of the Invention

The present invention relates to a technology that provides advertisement information over a network.

2. Description of the Related Art

There exist several ways (charge type) of charging for advertisement to be provided over a network. For example, the various types include an impression-guarantee type, an hourly charge type, a click charge type, a conversion charge type, and the like.

In the impression-guarantee type, presentation of a predetermined number of impressions (presentations) of advertisement within a predetermined time period is guaranteed for a client, and a lump sum charge is made on condition that the above agreement is executed.

In the hourly charge type, a charge is made according to a display time (a time period from when a screen of a page including advertisement to when the screen is shifted to another one or closed) of the advertisement. The hourly charge type includes a type in which an amount to be charged increases in a linear manner or a curved manner with respect to the display time, a type in which it is not until the display time exceeds a predetermined time that a charge is generated, a type in which the above two types are used in combination, and the like.

In the click charge type, a charge is not generated only by the presentation of advertisement, but generated on condition that a screen of the advertisement is clicked by a user to be shifted to a product page of an advertisement provider.

In the conversion charge type, a charge is not generated by the presentation of advertisement and user's click of the advertisement; but generated on condition that the user performs a predetermined action, such as member registration, document request, product purchase, on a product page of an advertisement provider.

Generally, in the impression-guarantee type, the number of impressions is large, so that the amount to be charged per one presentation is small. On the other hand, the amount to be charged generated when the charge condition is satisfied in each of the hourly charge type, click charge type, conversion charge type, and the like is significantly larger than the amount to be charged per one presentation in the impression-guarantee type.

Conventionally, a fixed charge type is assigned to an advertisement space provided on a page. That is, only an impression-guarantee type advertisement is displayed in an advertisement space for the impression-guarantee type, only an hourly charge type advertisement is displayed in an advertisement space for the hourly charge type, only a click charge type advertisement is displayed in an advertisement space for the click charge type, and only a conversion charge type advertisement is displayed in an advertisement space for the conversion charge type.

In Japanese Laid-open Patent Publication No. 2008-187383 (Japanese Patent No. 4825228) discloses a technology that converts the amount to be charged for each of advertisements of different charge types to an amount according to a uniform charge method, calculates an optimum value from the amount obtained by the conversion based on a previously set optimization rate, and selects one advertisement based on the calculated optimum values. In Japanese Laid-open Patent Publication No. 2009-187383, the optimum value is calculated in consideration of overall trend of all users.

As described above, one charge type is assigned to one advertisement space, so that the impression-guarantee type advertisement space is used only to get the number of presentations. That is, it is impossible to present, in the impression-guarantee type advertisement space, an advertisement of another charge type that brings about a large amount to be charged, thus limiting further improvement in earnings.

Further, the technology disclosed in Japanese Laid-open Patent Publication No. 2009-187383 only considers the overall trend of all users and does not consider trends of individual users, which may make it impossible to deliver an optimum advertisement in terms of the amount to be charged. For example, even if there is a trend in which a specific user is more likely to click an advertisement, an impression-guaranteed advertisement is delivered when a general trend indicates that the impression-guaranteed advertisement is advantageous, thus reducing the amount to be charged.

### SUMMARY OF THE INVENTION

It is an object of the present invention to at least partially solve the problems in the conventional technology. According to one aspect of an embodiment of the present invention an advertisement information providing device includes an advertisement content storage unit that stores advertisement content of a plurality of types different in charge type. The advertisement information providing device includes an expected earning calculation unit that calculates, when receiving a page browsing request from a terminal device of a user, expected earnings per unit impression number for each type of the advertisement content or for a combination of a plurality of types of the advertisement content based on behavior information of the user. The advertisement information providing device includes an advertisement content type determination unit that determines which type of the advertisement content or combination of types of the advertisement content is to be delivered based on the expected earnings calculated by the expected earning calculation unit. The advertisement information providing device includes an advertisement content delivery unit that acquires the type of the advertisement content or combination of types of the advertisement content determined by the advertisement content type determination unit from among types of the advertisement content stored in the advertisement content storage unit and delivers the advertisement content to an advertisement space included in a page browsed by the user who has made the page browsing request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration example of a system according to an embodiment of the present invention;

FIG. 2 is a view illustrating an example of a data structure of an advertisement DB;

FIG. 3 is a view illustrating an example of a data structure of a behavior history DB;

FIG. 4 is a view illustrating an example of a data structure of a page DB;

FIG. 5 is a view illustrating a data structure of an advertisement space DB;

FIG. 6 is a sequence diagram illustrating a processing example in the embodiment;

FIG. 7 is a (first) flowchart illustrating an example of advertisement content type determination processing;

FIG. 8 is a view illustrating a numerical relationship between the advertisement content of the impression-guarantee type and those of the other types;

FIG. 9 is a (second) flowchart illustrating an example of the advertisement content type determination processing; and

FIG. 10 is a view illustrating an example of calculation processing of the emergence score and other traffic.

### DETAILED DESCRIPTION OF THE PREFERRED EMBODIMENTS

A preferred embodiment of the present invention will be described below.

Configuration

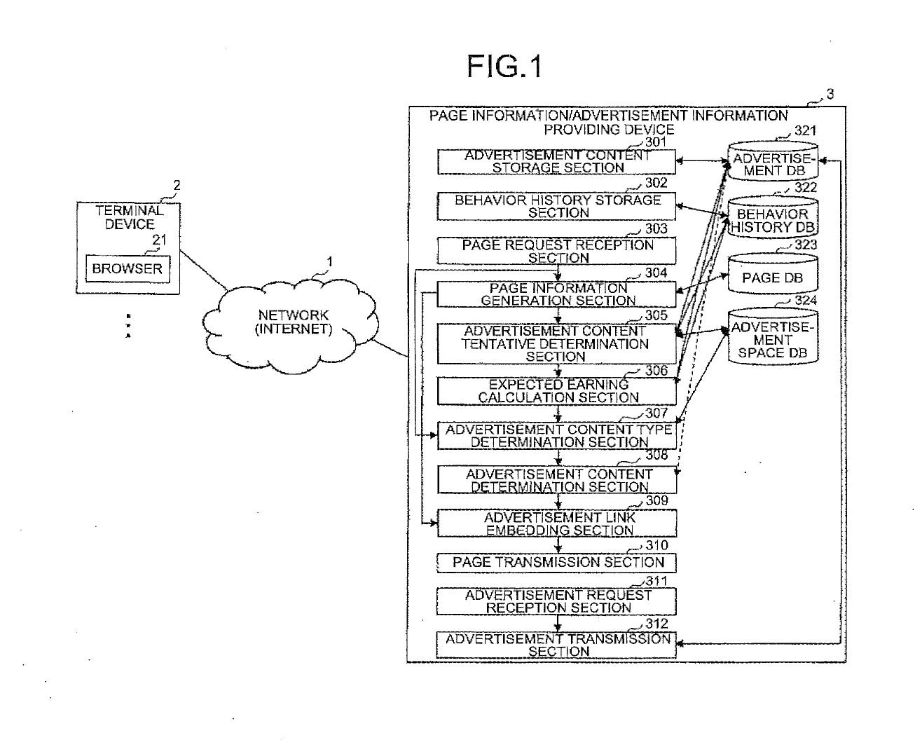

FIG. 1 is a configuration example of a system according to an embodiment of the present invention.

In FIG. 1, a network 1, such as the Internet, is connected with a plurality of user terminal devices 2, such as a smartphone, a mobile phone, and a PC (Personal Computer). The terminal device 2 includes a general browser (Web browser) 21. According to an HTTP (Hyper Text Transfer Protocol) which is a standard protocol of the Internet, the browser 21 requests, acquires, and displays page data described in language such as an HTML (Hyper Text Markup Language) and transmits form data.

The network 1 is further connected with a page information/advertisement information providing device 3 that provides page information and advertisement information in response to a request from the terminal device 2.

The page information/advertisement information providing device 3 includes, as functional sections, an advertisement content storage section 301, an behavior history storage section 302, a page request reception section 303, a page information generation section 304, an advertisement content tentative determination section 305, an expected earning calculation section 306, an advertisement content type determination section 307, an advertisement content determination section 308, an advertisement link embedding section 309, a page transmission section 310, an advertisement request reception section 311, and an advertisement transmission section 312.

The above functional sections are each realized by a computer program to be executed on hardware resources, such as a CPU (Central Processing Unit), a ROM (Read Only Memory), and a RAM (Random Access Memory), of a computer constituting the page information/advertisement information providing device 3. The functional sections need not be provided on a single computer, but may be provided in a distributed manner according to the need.

As a database that the page information/advertisement information providing device 3 uses, an advertisement DB 321, a behavior history DB 322, a page DB 323, and an advertisement space DB 324 are provided. These databases systematically retain predetermined data on a recording medium such as an HDD (Hard Disk Drive) in a computer constituting the page information/advertisement information providing device 3. The advertisement DB 321, behavior history DB 322, page DB 323, and advertisement space DB 324 need not be provided in the page information/advertisement information providing device 3 but may be provided in another device. As described above, advertisement content includes those of an impression-guarantee type, an hourly charge type, a click charge type, and a conversion charge type, which are different in manuscript submission form, so that advertisement content in the advertisement DB 321 may be divided by the advertisement content type.

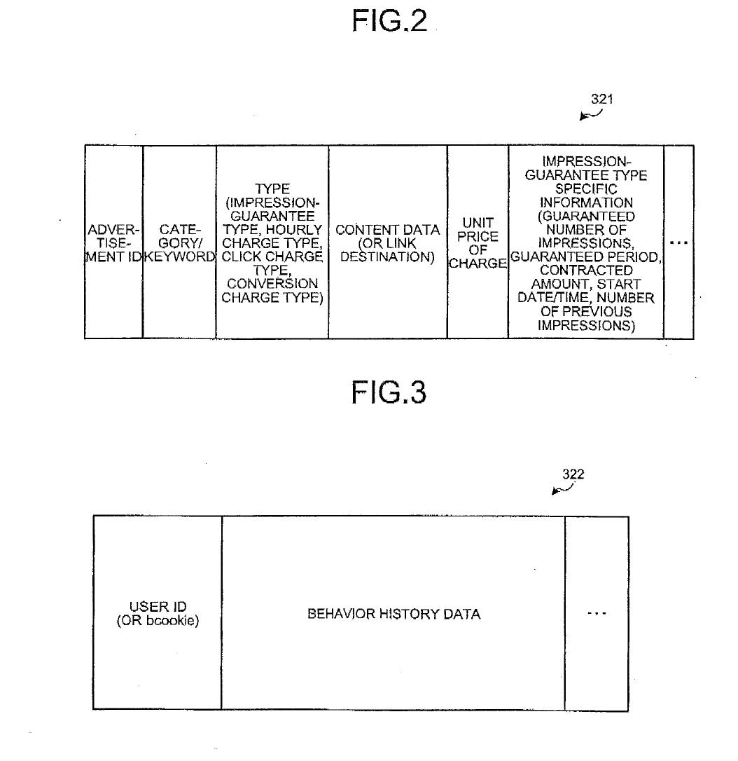

FIG. 2 is a view illustrating an example of a data structure of the advertisement DB 321. The data structure includes the following fields: “advertisement ID”, “category/keyword”, “type”, “content data”, “unit price of charge”, “impression-guarantee type specific information”, etc. The “advertisement ID” is information identifying the advertisement content. The “category/keyword” is a category to which the advertisement belongs or a keyword that clearly represents content of the advertisement. The “type” is a type of the advertisement content which is information indicating to which one of the impression-guarantee type, hourly charge type, click charge type, and conversion charge type the advertisement content belongs. It should be noted that the type of the advertisement content is not limited to those described above.

The “content data” is link information to a data body of the advertisement content or a storage location of the advertisement content. The “unit price of charge” is an amount to be charged per one impression in the case of the impression-guarantee type, is an amount to be charged per unit time (including a case where it differs for each time section when time and the amount to be charged are in a non-linear relationship) in one impression in the case of the hourly charge type, is an amount to be charged per one click in the case of the click charge type, and is an amount to be charged per one predetermined action in the case of the conversion charge type.

The “impression guarantee type specific information” includes “guaranteed number of impressions” which is the number of times the advertisement content is guaranteed to be displayed in a case where the advertisement content is the impression-guarantee type, “guaranteed period” during which the advertisement content is displayed, “contracted amount” which is an amount to be charged for the guaranteed number of impressions, “start date/time” which is a date/time at which display of the advertisement content is started, “number of previous impressions” which is the number of times the advertisement content is displayed, and the like.

FIG. 3 is a view illustrating an example of a data structure of the behavior history DB 322. The data structure includes items of “user ID”, “behavior history data”, and the like. The “user ID” is information identifying a user and includes a member ID that can identifies details of the user, a b-cookie (it is written as cookie information of a browser at first access time and is referred to at second and subsequent access time) based on which an access from the same browser can be identified, and the like. The “behavior history data” is history of user browsing, product purchase, and the like (including specific information, category, and date/time information of target advertisement content or product)

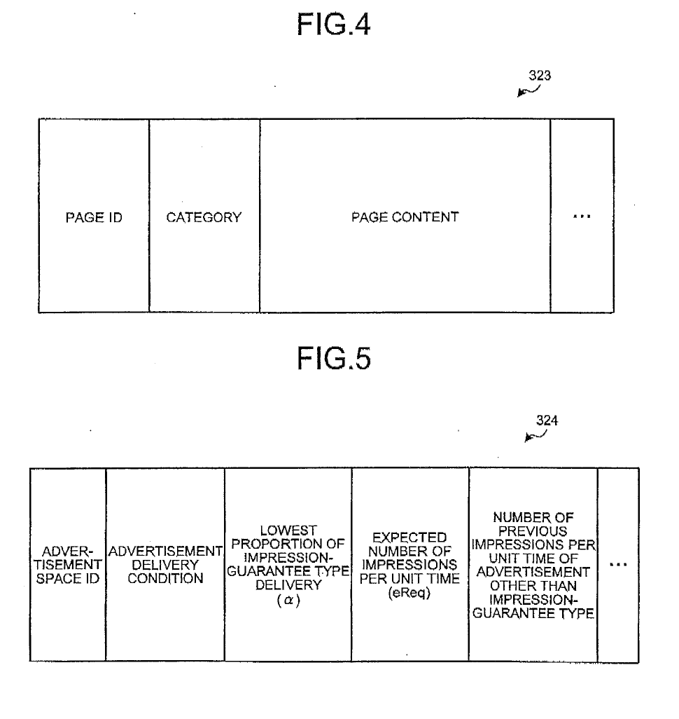

FIG. 4 is a view illustrating an example of a data structure of the page DB 323. The data structure includes items of “page ID”, “category”, “page content”, and the like. The “page ID” is information identifying a page. The “category” is information indicating a category to which the page belongs. The “page content” is information indicating main content of the page.

FIG. 5 is a view illustrating a data structure of the advertisement space DB 324. The data structure includes items of “advertisement space ID”, “advertisement delivery condition”, “lowest proportion of impression-guarantee type delivery”, “expected number of impressions per unit time”, “number of previous impressions per unit time of advertisement other than impression-guarantee type”, and the like. The “advertisement space ID” is information identifying an advertisement space. The “advertisement delivery condition” is information indicating advertisement delivery conditions such as interest match (ensuring of advertisement content matching user's likes and tastes) and content match (ensuring of advertisement content matching page content).

The “lowest proportion of impression-guarantee type delivery” is the lowest proportion at which the impression-guarantee type advertisement is to be delivered in the advertisement space. The “expected number of impressions per unit time” is the expected number of times at which the advertisement space is displayed per a predetermined unit time. The “number of previous impressions per unit time of advertisement other than impression-guarantee type” is the number of previous impressions per a predetermined unit time of the advertisement other than the impression-guarantee type advertisement content in the advertisement space.

Referring back to FIG. 1, the advertisement content storage section 301 of the page information/advertisement information providing device 3 stores, a predetermined timing, data of advertisement content provided from an advertisement provider, such as the advertisement ID, category/keyword, type, content data, unit price of charge, and impression-guarantee type specific information (only in the case where the impression-guarantee type is provided) in the advertisement DB 321.

The behavior history storage section 302 monitors user's behavior of browsing the browser 21 of the terminal device 2 and stores behavior history data in the behavior history DB 322 in association with the user ID.

The page request reception section 303 receives a page browsing request from the browser 21 of the terminal device 2.

The page information generation section 304 generates page information corresponding to the page browsing request that the page request reception section 303 receives by referring to the page DB 323 and the like. The page to be generated includes the advertisement space,

The advertisement content tentative determination section 305 tentatively determines advertisement content of each type (impression-guarantee type, hourly charge time, click charge type, and conversion charge type) based on an advertisement delivery condition (advertisement space DB 324) set for the advertisement space included in the page generated by the page information generation section 304.

The expected earning calculation section 306 calculates expected earnings (eCPM) per unit impression number (e.g., 1000 times) for each type of the advertisement content based on the behavior history data of the user of the terminal device 2 which is a page request source, page information generated by the page information generation section 304, and advertisement content of each type tentatively determined by the advertisement content tentative determination section 305. Details of the calculation will be described later.

The advertisement content type determination section 307 selects the impression-guarantee type as the type of the advertisement content, considering the number of deliveries of the impression-guarantee type advertisement content for which a contract requires that a predetermined number of deliveries should be made. Alternatively, in a case where there is no need to limit the type of the advertisement content to the impression-guarantee type, the advertisement content type determination section 307 determines, based on the expected earnings calculated by the expected earning calculation section 306, which type of the advertisement content is to be delivered. Details of the determination processing will be described later.

The advertisement content determination section 308 determines, based on the advertisement content determined by the advertisement content tentative determination section 305 and the type determined by the advertisement content type determination section 307, advertisement content to be actually delivered.

The advertisement link embedding section 309 embeds a link to the advertisement content determined by the advertisement content determination section 308 in the advertisement space of the page generated by the page information generation section 304. For example, an advertisement ID is added as a parameter to a URL of the page information/advertisement information providing device 3. The advertisement link embedding section 309 may embed data itself of the advertisement content in the page in place of embedding the link.

The page transmission section 310 transmits the page information to the browser 21 of the terminal device 2 as the request source.

The advertisement request reception section 311 receives an advertisement content request based on the link embedded in the advertisement space while the browser 21 of the terminal device 2 renders a screen from the page information. When the data itself of the advertisement content is embedded in the advertisement frame, the advertisement content request is not made.

The advertisement transmission section 312 transmits, when the advertisement request reception section 311 receives the advertisement content request, data of the corresponding advertisement content to the browser 21 of the terminal device 2.

Operation

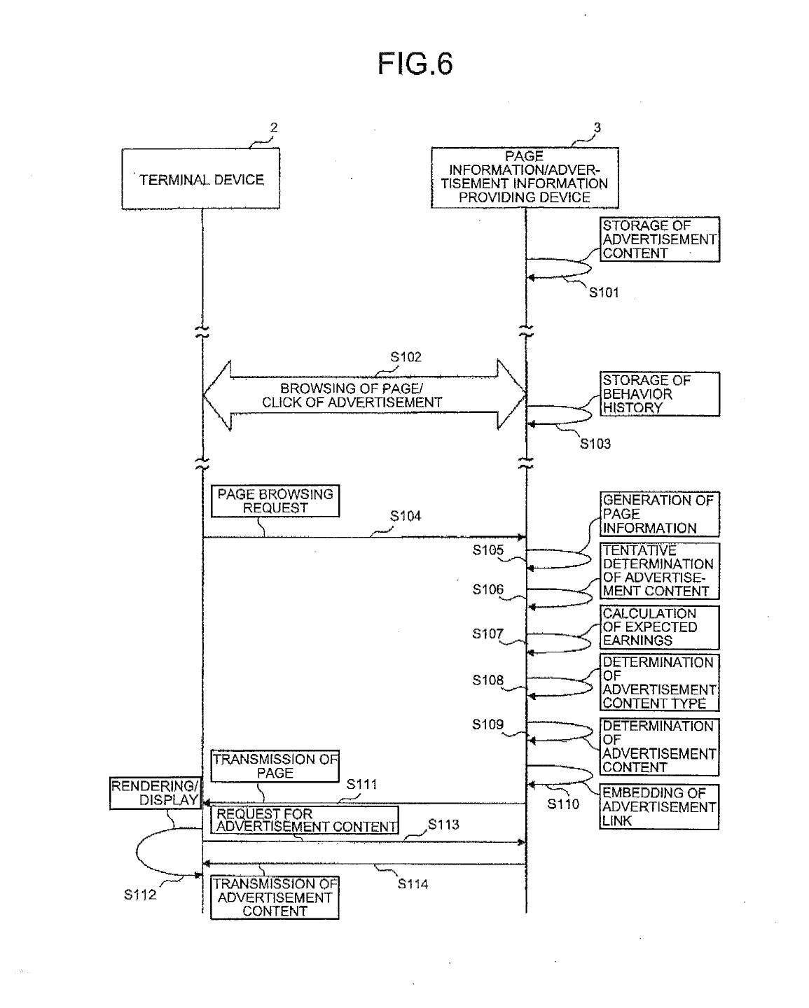

FIG. 6 is a sequence diagram illustrating a processing example in the embodiment.

In FIG. 6, the advertisement content storage section 301 of the page information/advertisement information providing device 3 stores, at a predetermined timing, data of advertisement content provided from an advertisement provider, such as the advertisement ID, category/keyword, type, content data, unit price of charge, and impression-guarantee type specific information (only in the case where the impression-guarantee type is provided) in the advertisement DB 321 (step S101).

Thereafter, when a user browses a page on the browser 21 of the terminal device 2 through his or her operation (step S102), the behavior history storage section 302 of the page information/advertisement information providing device 3 stores the behavior history data in the behavior history DB 322 in association with the user ID (step S103). Thereafter, the page browsing request is made from the browser 21 of the terminal device 2. Upon reception of the page browsing request by the page request reception section 303 of the page information/advertisement information providing device 3 (step S104), the page information generation section 304 of the page information/advertisement information providing device 3 generates the page information corresponding to the received page browsing request by referring to the page DB 323 and the like (step S105).

Then, the advertisement content tentative determination section 305 tentatively determines advertisement content of each type based on an advertisement delivery condition (advertisement space DB 324) set for the advertisement space included in the page generated by the page information generation section 304 (step S106). For example, when the advertisement delivery condition is that advertisement content of a category that occurs frequently in the user's behavior history data should be delivered, the advertisement content tentative determination section 305 refers to behavior history data -of the behavior history DB 322 based on the user ID of the user that has made the page request, extracts a frequently occurring category, and selects advertisement content of the extracted category from each type for tentative determination. Further, when the advertisement delivery condition is that advertisement content corresponding to a category of a page content or a phrase that occurs frequently in the page should be delivered, the advertisement content tentative determination section 305 refers to the page information generated by the page information generation section 304, extracts a category/keyword associated with the page or frequently occurring phrase in the page, and selects advertisement content associated with the category/keyword or phrase from each type for tentative determination.

A configuration may be adopted, except for the advertisement content of impression-guarantee type, wherein the advertisement content tentative determination section 305 tentatively determines, not the advertisement content itself, but only an item, such as category/keyword, required to calculate the expected earnings, and the advertisement content determination section 308 determines the advertisement content to be actually delivered in the subsequent step.

Subsequently, the expected earning calculation section 306 calculates expected earnings (eCPM) per unit impression number (e.g., 1000 times) for each type of the advertisement content based on the behavior history data of the user of the terminal device 2 which is a page request source, page information generated by the page information generation section 304, and advertisement content of each type tentatively determined by the advertisement content tentative determination section 305 (step S107).

In a case where the impression-guarantee type is selected as the advertisement content type without consideration on the expected earnings in the subsequent advertisement content type determination processing, there is no need to perform the calculation of the expected earnings. Thus, the calculation of the expected earnings may be performed only when it is determined, in the advertisement content type determination processing, that the advertisement content type is not limited to the impression-guarantee type.

The calculation of the expected earnings is made based on the following expressions.

Impression-guarantee type:

eCPM=contracted amount/guaranteed number of impressions×1000

Hourly charge type:

eCPM=estimated display time×amount to be charge per unit time×1000

Click charge type:

eCPM=estimated CTR×amount to be charged×1000

Conversion charge type:

eCPM=estimated CTR×estimated CVR×amount to be charged×1000

The “contracted amount” and guaranteed number of impressions are acquired from the impression-guarantee type specific information of the advertisement pH 321 (FIG. 2). The “estimated display time” is acquired by referring to the behavior history data of a corresponding user in the behavior history DB 32 (FIG. 3) and calculating an estimated time of the advertisement content of the same category, etc., in the page of the same category, etc. Note that by calculating the estimated display time for all users as well as the estimated display time for one target user, it is possible to calculate final estimated display time based on results of the above two calculations. The estimated display time for all users is calculated by statistical processing (e.g., simply an average value is calculated as the estimated display time, or a display time considering a deviation, for which predetermined reliability can be expected is calculated) based on the estimated display time for each of all the users. The final estimated display time based on results of the estimated display time for all users and estimated display time for one target user is obtained by averaging the results of the two calculations. Alternatively, the estimated display time may be calculated simply based on the display time for the user without consideration on the category of the page or advertisement content.

The “amount to be charged per unit time” is acquired from the unit price of charge of the advertisement DB 321 (FIG. 2). The “estimated CTR” is acquired by referring to the behavior history data of a corresponding user in the behavior history DB 322 (FIG. 3) and calculating a CTR (Click Through Rate: a rate of clicks to impressions) of the advertisement content of the same category, etc., in the page of the same category, etc. The “amount to be charged” is acquired from the unit price of charge of the advertisement DB 321 (FIG. 2). The “estimated CVR” is acquired by referring to the behavior history data of a corresponding user in the behavior history DB 322 (FIG. 3) and calculating a CVR (Conversion Rate; a rate of behaviors such as product purchase to impressions) of the advertisement content of the same category, etc., in the page of the same category, etc.

The above-described calculation example of the expected earnings (eCPM) assumes that the advertisement content of each type is delivered at that time point of finishing calculation of the eCPM, and, in a system in which the advertisement content in the advertisement space of the page is updated every predetermined time (e.g., 20 seconds), the expected earnings can be calculated based on the display time also for a combination (when the advertisement content sequentially updated is limited to the same type) of a plurality of items of advertisement content of the same time or a combination (when the advertisement content sequentially updated is not limited to the same type) of a plurality of items of advertisement content of different types, as a selectable candidate. For example, assume that an update period is 20 seconds and the expected display time is 44.5 seconds. In this case, when the items of advertisement contents to be updated are not limited to the same type, the hourly charge type (e.g., 2 yen) is set in the first 20 seconds, the hourly change type (e.g., 2 yen) is set in the second 20 seconds, and the impression-guarantee type (e.g., 1 yen) is set in the last 4.5 seconds, whereby advantageous expected earnings can be obtained.

Subsequently, the advertisement content type determination section 307 of the page information/advertisement information providing device 3 selects the impression-guarantee type as the type of the advertisement content, considering the number of deliveries of the impression-guarantee type advertisement content for which a contract requires that a predetetermined number of deliveries should be made. Alternatively, in a case where there is no need to limit the type of the advertisement content to the impression-guarantee type, the advertisement content type determination section 307 determines, based on the expected earnings calculated by the expected earning calculation section 306, which type of the advertisement content is to be delivered (step S107). In principle, in the case where there is no need to limit the type of the advertisement content to the impression-guarantee type, a type for which the highest earnings are expected is selected. The type to be selected here includes the impression-guarantee type. Note that in a case where the expected earnings are calculated for a combination of a plurality of items of advertisement content, the combination is included in choices.

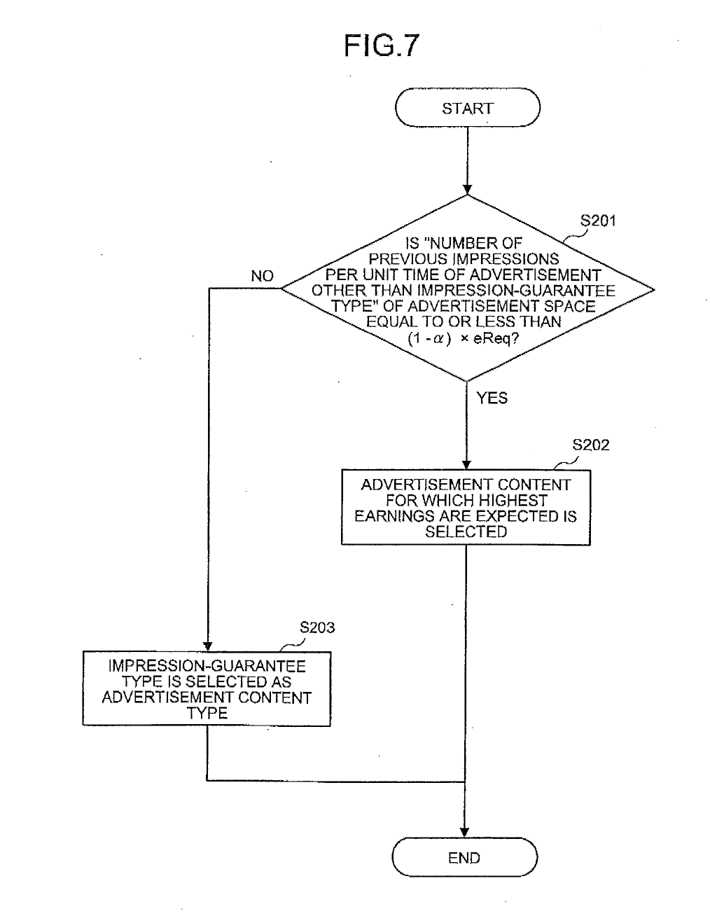

FIG. 7 is a flowchart illustrating an example of advertisement content type determination processing.

In FIG. 7, the advertisement content type determination section 307 determines whether or not the “number of previous impressions per unit time of advertisement other than impression-guarantee type” of the advertisement space is equal to or less than (1−α)×eReq (step S201). In the above expression, α is the “lowest proportion of impression-guarantee type delivery” of the advertisement space DB 324 (FIG. 5), and eReq is the “expected number of impressions per unit time” of the advertisement space DB 324 (FIG. 5).

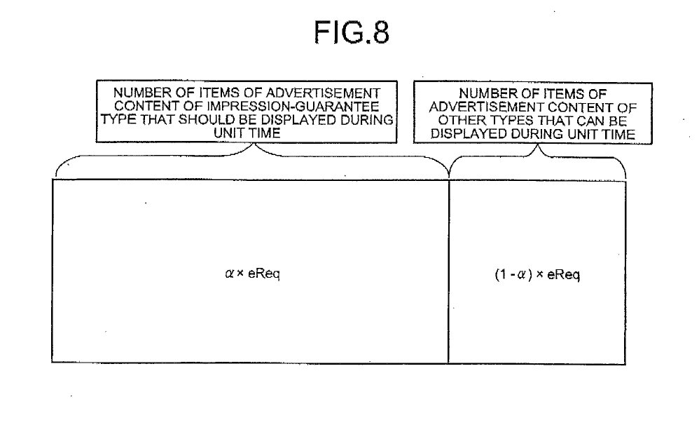

FIG. 8 is a view illustrating a numerical relationship between the advertisement content of the impression-guarantee type and those of the other types. The number of items of advertisement content of the impression-guarantee type that should be displayed during unit time is represented by α×eReq, and the number of items of advertisement content of the other types that can be displayed during unit time is represented by (1−α)×eReq.

Referring back to FIG. 7, when the “number of previous impressions per unit time of advertisement other than impression-guarantee type” of the advertisement space is equal to or less than (1−α)×eReq (Yes in step S201), it is determined that there is no need to preferentially display the advertisement content of impression-guarantee type, and a type (any one of all the types including the impression-guarantee type) for which the highest earnings are expected is selected (step S202).

When the “number of previous impressions per unit time of advertisement other than impression-guarantee type” of the advertisement space is not equal to or less than (1−α)×eReq (No in step S201), it is determined that there is a need to preferentially display the advertisement content of impression-guarantee type, and the impression-guarantee type is selected as the advertisement content type (step S203).

Referring back to FIG. 6, the advertisement content determination section 308 of the page information/advertisement information providing device 3 determines, based on the advertisement content determined by the advertisement content tentative determination section 305 and the type determined by the advertisement content type determination section 307, advertisement content to be actually delivered (step S109),

Subsequently, the advertisement link embedding section 309 embeds a link to the advertisement content determined by the advertisement content determination section 308 in the advertisement space of the page generated by the page information generation section 304 (step S110).

Subsequently, the page transmission section 310 of the page information/advertisement information providing device 3 transmits the page information to the browser 21 of the terminal device 2 as the request source (step S111).

In response to this, the browser 21 of the terminal device 2 performs rendering based on the page information to perform screen display (step S112) and, in this process, makes an advertisement content request based on the link embedded in the advertisement space (step S113),

Upon reception of the advertisement content request by the advertisement request reception section 311 of the page information/advertisement information providing device 3, the advertisement transmission section 312 transmits data of the corresponding advertisement content to the browser 21 of the terminal device 2 as the request source (step S114). A configuration may be adopted in which a redirection of the advertisement request from the advertisement space in the displayed page is received by an advertisement delivery server for delivery.

Another Example of Advertisement Type Determination Processing

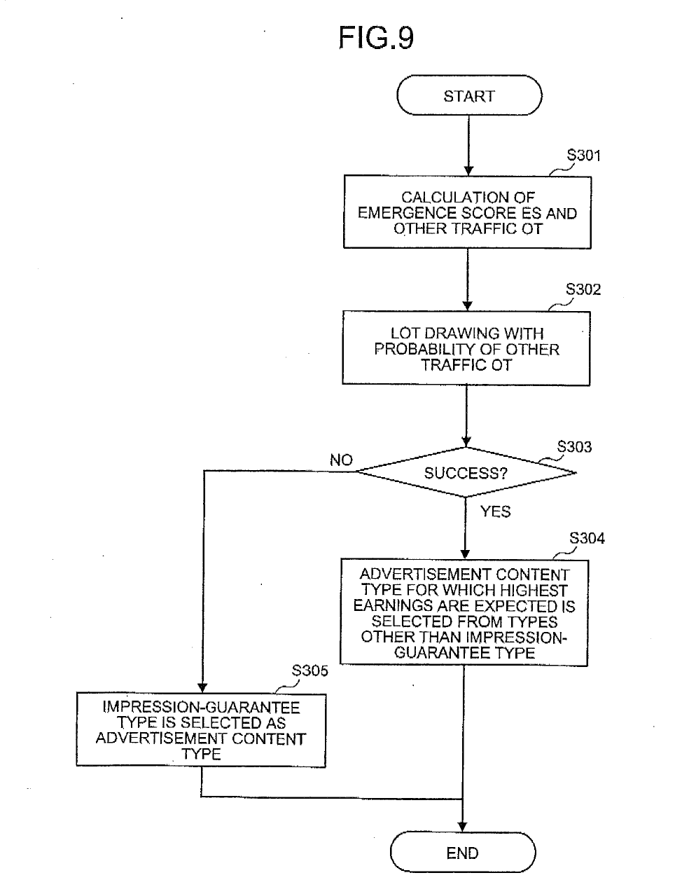

FIG. 9 is a flowchart illustrating another example of the advertisement content type determination processing (step S108 of FIG. 6).

In FIG. 9, the advertisement content type determination section 307 of the page information/advertisement information providing device 3 calculates an emergence score ES and another traffic OT (step S301). The emergence score ES is a value indicating a potential proportion of unused items of advertisement content of the impression-guarantee type relative to all items of the advertisement content. The other traffic OT is a value indicating an allowance proportion of the advertisement content other than the impression-guarantee type for the advertisement space.

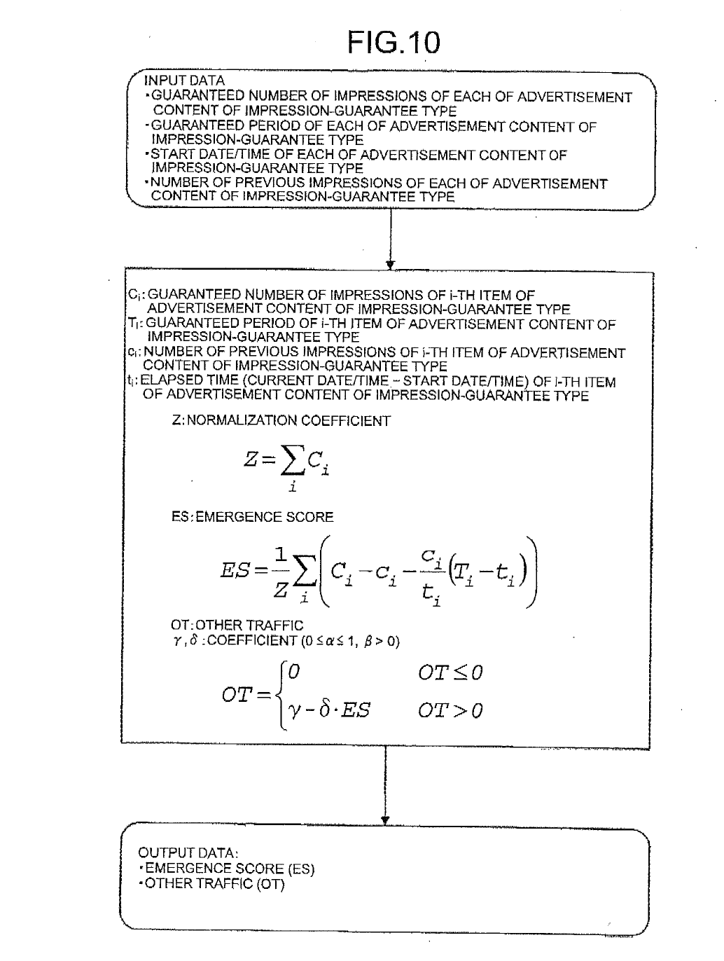

FIG. 10 is a view illustrating an example of calculation processing of the emergence score and other traffic.

As input data, the guaranteed number of impressions, guaranteed period, start date/time, and number of previous impressions of the target advertisement content of impression-guarantee type are acquired from the impression-guarantee type specific information of the advertisement DB 321. Then, with the guaranteed number of impressions of an i-th item of advertisement content of impression-guarantee type being Cᵢ, the guaranteed period of the i-th items of advertisement content of impression-guarantee type being Tᵢ, the number of previous impressions of the i-th item of advertisement content of impression-guarantee type being cᵢ, and an elapsed time (current date/time-start data/time) of the i-th item of advertisement content of impression-guarantee type being tᵢ, a normalization coefficient Z is calculated according to an illustrated expression, the emergency score ES is calculated, and then the other traffic OT is calculated. In the expression for calculating the other traffic OT, y is a coefficient with which a proportion of the advertisement coefficient other than the impression-guarantee type relative to the entire traffic becomes maximum, and δ is a coefficient for adjusting a value of the emergence score. Then, the calculated emergence score and other traffic are output,

Referring back to FIG. 9, the advertisement content type determination section 307 performs a lot drawing with a probability of the other traffic OT (step S302). When the lot drawing results in a success (Yes in step S303), an advertisement content type for which the highest earnings are expected is selected from the types other than the impression-guarantee type (step S304).

When the lot drawing results in a failure (No in step S303), the impression-guarantee type is selected as the advertisement content type (step S305).

As described above, according to the present embodiment, advertisements of a plurality of types different in way of charging are delivered in a flexible manner to thereby achieve an increase in earnings.

According to the present invention, advertisements of a plurality of types different in way of charging are delivered in a flexible manner to thereby achieve an increase in earnings.

Although the invention has been described with respect to specific embodiments for a complete and clear disclosure, the appended claims are not to be thus limited but are to be construed as embodying all, modifications and alternative constructions that may occur to one skilled in the art that fairly fall within the basic teaching herein set forth.

What is claimed is:

1. An advertisement information providing device comprising:
an advertisement content storage unit that stores advertisement content of a plurality of types different in charge type;
an expected earning calculation unit that calculates, when receiving a page browsing request from a terminal device of a user, expected earnings per unit impression number for each type of the advertisement content or for a combination of a plurality of types of the advertisement content based on behavior information of the user;
an advertisement content type determination unit that determines which type of the advertisement content or combination of types of the advertisement content is to be delivered based on the expected earnings calculated by the expected earning calculation unit; and
an advertisement content delivery unit that acquires the type of the advertisement content or combination of types of the advertisement content determined by the advertisement content type determination unit from among types of the advertisement content stored in the advertisement content storage unit and delivers the advertisement content to an advertisement space included in a page browsed by the user who has made the page browsing request.

2. The advertisement information providing device according to claim 1, wherein
the advertisement content type determination unit selects, as the advertisement content type to be delivered, the impression-guarantee type, with considering the number of deliveries of impression-guarantee type advertisement content for which a contract requires that a predetermined number of deliveries should be made, and determines, based on the expected earnings, which type of the advertisement content or combination of types of the advertisement content is to be delivered in a case where there is no need to limit the type of the advertisement content to the impression-guarantee type.

3. The advertisement information providing device according to claim 2, wherein
the advertisement content type determination unit selects, as the advertisement content type to be delivered, a type or combination for which the highest earnings are expected when the number of previous impressions of the impression-guarantee type advertisement content is equal to or less than a predetermined value and selects the impression-guarantee type when the number of impressions is not equal to or less than the predetermined value.

4. The advertisement information providing device according to claim 2, wherein
the advertisement content type determination unit calculates other traffic indicating an allowance proportion of the advertisement content other than the impression-guarantee type for the advertisement space based on an emergence score indicating a potential proportion of unused items of impression-guarantee type advertisement content relative to all items of the advertisement content, performs a lot drawing with a probability of the other traffic, and selects, as the advertisement content type to be delivered, an advertisement content type for which the highest earnings are expected from the types other than the impression-guarantee type when the lot drawing results in a success, or the impression-guarantee type when the lot drawing results in a failure.

5. An advertisement information providing method, performed by an advertisement information providing device, comprising:
storing includes storing advertisement content of a plurality of types different in charge type;
calculating includes calculating, when receiving a page browsing request from a terminal, device of a user, expected earnings per unit impression number fox each type of the advertisement content or for a combination of a plurality of types of the advertisement content based on behavior information of the user;
determining includes determining which type of the advertisement content or combination of types of the advertisement content is to be delivered based on the expected earnings calculated at the calculating;
acquiring includes acquiring the type of the advertisement content or combination of types of the advertisement content determined at determining from among the advertisement content stored at the storing; and
delivering includes delivering the advertisement content to an advertisement space included in a page browsed by the user who has made the page browsing request.

6. The advertisement information providing method according to claim 5, wherein
the determining includes selecting, as the advertisement content type to be delivered, the impression-guarantee type, with considering the number of deliveries of impression-guarantee type advertisement content for which a contract requires that a predetermined number of deliveries should be made, and determining, based on the expected earnings, which type of the advertisement content or combination of types of the advertisement content is to be delivered in a case where there is no need to to limit the type of the advertisement content to the impression-guarantee type.

7. The advertisement information providing method according to claim 6, wherein
the determining includes selecting, as the advertisement content type to be delivered, a type or combination for which the highest earnings are expected when the number of previous impressions of the impression-guarantee type advertisement content is equal to or less than a predetermined value and selecting the impression-guarantee type when the number of impressions is not equal to or less than the predetermined value.

8. The advertisement information providing method according to claim 6, wherein
the determining includes,
calculating other traffic indicating an allowance proportion of the advertisement content other than the impression-guarantee type for the advertisement space based on an emergence score indicating a potential proportion of unused items of impression-guarantee type advertisement content relative to all items of the advertisement content,
performing a lot drawing with a probability of the other traffic, and
selecting, as the advertisement content type to be delivered, an advertisement content type for which the highest earnings are expected from the types other than the impression-guarantee type when the lot drawing results in a success, or the impression-guarantee type when the lot drawing results in a failure.
